(19) United States
(12) Patent Application Publication
(10) Pub. No.: US 2013/0230276 A1
(43) Pub. Date: Sep. 5, 2013

(54) OPTICAL PRINTED CIRCUIT BOARD, APPARATUS AND METHOD FOR MANUFACTURING SAME

(71) Applicant: BING-HENG LEE, Tu-Cheng (TW)

(72) Inventor: BING-HENG LEE, Tu-Cheng (TW)

(73) Assignee: HON HAI PRECISION INDUSTRY CO., LTD., Tu-Cheng (TW)

(21) Appl. No.: 13/584,760

(22) Filed: Aug. 13, 2012

(30) Foreign Application Priority Data
Mar. 2, 2012 (TW) 101107005

(51) Int. Cl. G02B 6/132; B05D 5/06; B05C 11/02

(52) U.S. Cl. 385/14; 118/67; 118/642; 427/163.2

(57) ABSTRACT

An optical printed circuit board (OPCB) includes a flexible first substrate, a first cladding layer, a core layer, a second cladding layer, and a flexible second substrate. The first cladding layer is formed on the substrate. The core layer is formed on the first cladding layer. The second layer is formed on the core layer. The second substrate is positioned on the second cladding layer. The core layer defines optical waveguide patterns. The refractive rate of the core layer is greater than the refractive rate of the first cladding layer and the refractive rate of the second cladding layer.

### BACKGROUND

1. Technical Field

The present disclosure relates to an optical printed circuit board (OPCB), an apparatus and a method for manufacturing the OPCB.

2. Description of Related Art

Many OPCBs use rigid substrates. During manufacturing process, one rigid substrate needs to be assembled on an apparatus for manufacturing the OPCBs, then the formed OPCB needs to be taken off the apparatus, and another rigid substrate needs to be placed on the apparatus, and so on, which will reduce the manufacturing efficiency of the OPCBs.

Therefore, it is desirable to provide an OPCB, an apparatus and a method for manufacturing the OPCB that can overcome the above-mentioned limitations.

### BRIEF DESCRIPTION OF THE DRAWINGS

Many aspects of the embodiments will be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a cross-sectional view of an OPCB, according to a first embodiment.

FIG. 2 is a schematic view of an apparatus for manufacturing the OPCB of FIG. 1, according to a second embodiment.

FIG. 3 is a flowchart of a method for manufacturing the OPCB of FIG. 1, according to a third embodiment.

### DETAILED DESCRIPTION

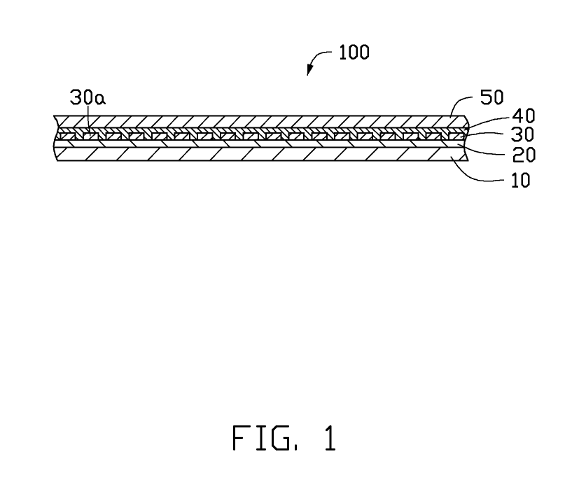

FIG. 1 illustrates an optical printed circuit board (OPCB) 100 in accordance with a first embodiment. The OPCB 100 includes a flexible first substrate 10, a first cladding layer 20, a core layer 30, a second cladding layer 40, and a flexible second substrate 50.

The first cladding layer 20 is formed on the first substrate 10. The core layer 30 is formed on the first cladding layer 20 so as to define an optical waveguide pattern 30a. The second cladding layer 40 is formed on the core layer 30. The second substrate 50 is formed on the second cladding layer 40.

The first substrate 10 and the second substrate 50 protect the first cladding layer 20 and the second cladding layer 40 respectively. In this embodiment, the first substrate 10 and the second substrate 50 are made of polyethylene terephthalate (PET). In another embodiment, the first substrate 10 and the second substrate 50 can be made of polyethersulfone (PES) or other flexible transparent material.

The first cladding layer 20 and the second cladding layer 40 protect the core layer 30 and allow optical signals to be transmitted only along the core layer 30. The first cladding layer 20 and the second cladding layer 40 are made of low refractive material, such as the following materials without light sensitive groups: polyacrylate, polysiloxane, polyimide, polycarbonate, fluorinated polymer, or mixture of at least two above materials. In this embodiment, the material of the first cladding layer 20 is substantially the same as the material of the second cladding layer 40. In other embodiments, the material of the first cladding layer 20 can be different from the material of the second cladding layer 40.

The refractive index of the core layer 30 is greater than the refractive index of the first cladding layer 20 and the refractive index of the second cladding layer 40. The core layer 30 is made of high refractive index material, such as the following materials with light sensitive groups: polyacrylate, polysiloxane, polyimide, polycarbonate, fluorinated polymer, or mixture of at least two above materials.

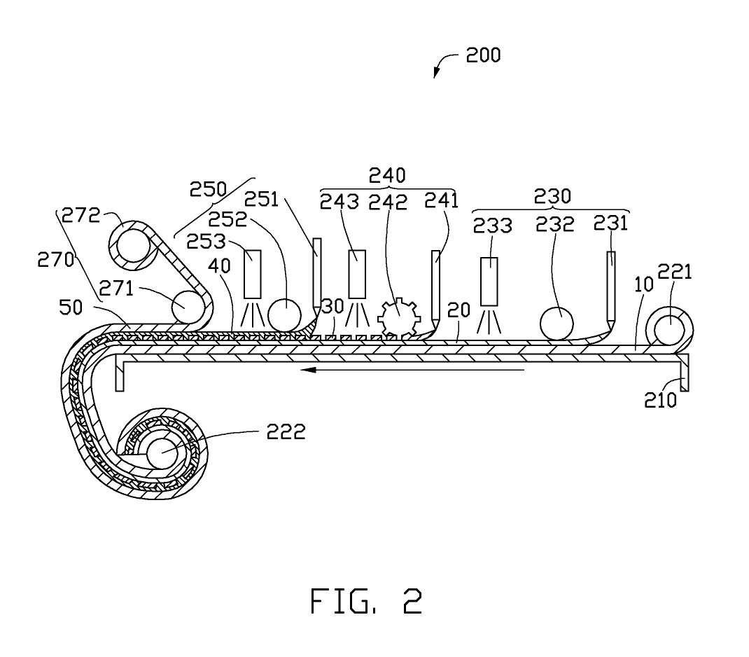

Referring to FIG. 2, an apparatus 200 for manufacturing the OPCB of FIG. 1, according to a second embodiment, includes a working platform 210, a first releasing reel 221, and a film take-up reel 222. The apparatus 200 further includes a first roller pressing device 230, a second roller pressing device 240, a third roller pressing device 250, and a fourth roller pressing device 270 on a top of the working platform 210 and arranged one after the other along the direction of movement of the first substrate 10.

The first releasing reel 221 and the film take-up reel 222 are arranged at two ends of the working platform 210. The first releasing reel 221 is used for paying out the first substrate 10, and the film take-up reel 222 is used for taking up the formed OPCB 100. The first roller pressing device 210 is used for forming the first cladding layer 20 on the substrate 10. The second roller pressing device 220 is used for forming the core layer 30 on the first cladding layer 20. The third roller pressing device 230 is used for forming the second cladding layer 40 on the core layer 30. The fourth roller pressing device 240 is used for pressing the second substrate 50 on the second cladding layer 40.

The first roller pressing device 230 includes a first feeder 231, a first pressing roller 232, and a first drying element 233. The first pressing roller 232 is a copper-coated roller and has a smooth rolling surface. The first feeder 231 is arranged between the releasing reel 221 and the first pressing roller 232 and is used for feeding a first cladding layer forming solvent to the substrate 10. The first cladding layer forming solvent is a solvent for forming the first cladding layer 20. The first pressing roller 232 and the working platform 210 cooperate to press the first cladding layer forming solvent on the substrate 10 to obtain a first cladding solvent layer. The first cladding solvent layer is a layer of the first cladding layer forming solvent. The first drying device 233 is arranged after the first pressing roller 232 and is used for drying the first cladding solvent layer to obtain the first cladding layer 20. In this embodiment, the first drying element 233 is an ultraviolet source.

The second roller pressing device 240 includes a second feeder 241, a second pressing roller 242, and a second drying element 243. The second pressing roller 242 is a copper-coated roller and has a rolling surface defining impression patterns coupled with the optical waveguide pattern. The second feeder 241 is arranged between the first roller pressing device 230 and the second pressing roller 242 and feeds a core layer forming solvent to the substrate 10. The core layer forming solvent is a solvent for forming the core layer 30. The second pressing roller 242 and the working platform 10 cooperate to press the core layer forming solvent on the first cladding layer 20 to obtain a core solvent layer. The core solvent layer is a layer of the core layer forming solvent. The first drying device 243 is arranged after the second pressing roller 242 and dries the core solvent layer to obtain the core layer 30. In this embodiment, the second drying element 243 is an ultraviolet source.

The third roller pressing device 250 includes a third feeder 251, a third pressing roller 252, and a third drying element 253. The third pressing roller 252 is a copper-coated roller and has a smooth rolling surface. The third feeder 253 is arranged between the second roller pressing device 240 and the third pressing roller 252 and is used for feeding a second cladding layer forming solvent to the core layer 30. The second cladding layer forming solvent is a solvent for forming the second cladding layer 40. The third pressing roller 252 and the working platform 10 cooperate to press the third cladding layer forming solvent on the core layer 30 to obtain a second cladding solvent layer 40. The second cladding solvent layer is a layer of the second cladding layer forming solvent. The third drying device 253 is arranged after the third pressing roller 252 and is used for drying the second cladding solvent layer to obtain the second cladding layer 40. In this embodiment, the second drying element 253 is an ultraviolet source.

The fourth roller pressing device 270 includes a fourth pressing roller 271 and a second releasing reel 272. One end of the second substrate 50 is wound around the second releasing reel 272, and the other end of the second substrate 50 is pressed on the second cladding layer 40 by the fourth pressing roller 271.

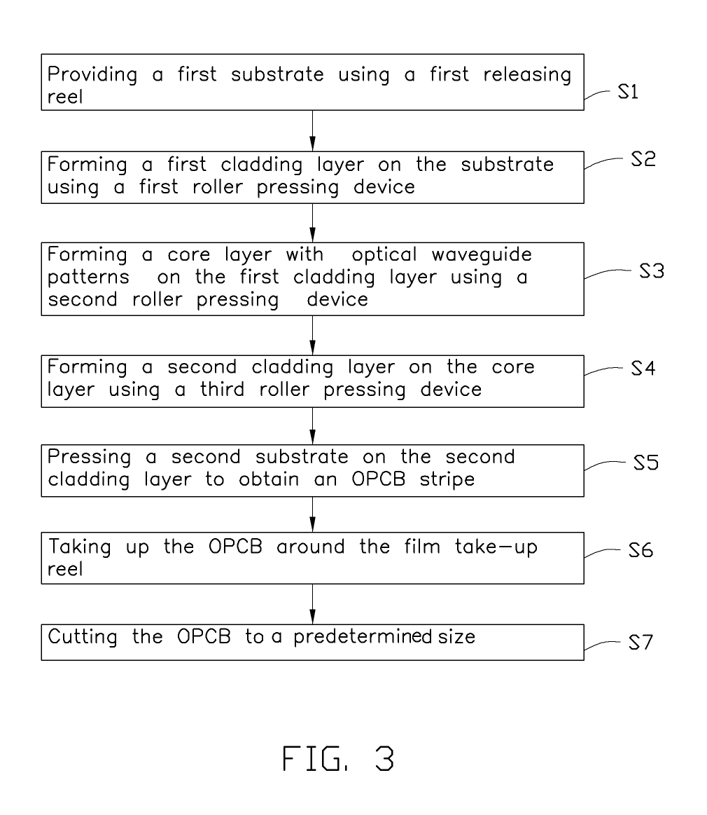

Referring to FIG. 3, a method for manufacturing the OPCB 100 using the apparatus 200, according to a third embodiment, includes the following steps.

In step S1, the flexible first substrate 10 is cleaned and then rolled out from the first releasing reel 221. In particular, one end of the first substrate 10 is wound around the first releasing reel 221, and the other end of the first substrate 10 is fixed on the film take-up reel 222. The first releasing reel 221 and the film take-up reel 222 are spaced at a predetermined distance from each other. The first substrate 10 is released on the working platform 210. A moving direction of the first substrate 10 is substantially parallel to a length direction of the working platform 210. The first substrate 10 is cleaned to improve the adhesive potential of the first cladding layer 20 on the first substrate 10.

In step S2, a first cladding layer 20 is formed on the first substrate 10 using the first roller pressing device 230. In this embodiment, the first feeder 231 feeds the first cladding layer forming solvent to the first substrate 10. The first substrate 10 passes through a channel between the first pressing roller 232 and the working platform 210. The first pressing roller 232 presses the first cladding layer forming solvent on the first substrate 10 to obtain the first cladding solvent layer. The first drying element 233 solidifies the first cladding solvent layer to form the first cladding layer 20.

In step S3, a core layer 30 is formed on the first cladding layer 20 using the second roller pressing device 240. In this embodiment, the second feeder 241 feeds the core layer forming solvent to the first cladding layer 20. The first substrate 10 with the first cladding layer 20 passes through a channel between the second pressing roller 241 and the working platform 210, the second pressing roller 242 presses the core layer forming solvent on the first cladding layer 20 to obtain the core solvent layer. The second drying device 243 solidifies the core solvent layer to obtain the core layer 30.

In step S4, a second cladding layer 40 is formed on the core layer 30 using the third roller pressing device 250. In this embodiment, the third feeder 251 feeds the second cladding layer forming solvent to the core layer 30. The first substrate 10 with the first cladding layer 20 and the core layer 30 passes through a channel between the third pressing roller 252 and the working platform 210. The third pressing roller 252 presses the second cladding layer forming solvent on the core layer 30 to form the second cladding solvent layer. The third drying device 253 solidifies the second cladding solvent layer to form the second cladding layer 40.

In step S5, a flexible second substrate 50 is formed on the second cladding layer 40 to obtain the OPCB 100 using the fourth roller pressing device 270. In this embodiment, the second release reel 272 pays out the second substrate 50 onto the second cladding layer 40. The first substrate 10 with the first cladding layer 20, the core layer 30, and the second cladding layer 40 passes through a channel between the fourth pressing roller 271 and the working platform 210. The fourth pressing roller 271 presses the second substrate 50 on the second cladding layer 40.

In step S6, the film take-up reel 222 takes up the formed OPCB 100.

In step S7, the formed OPCB 100 is cut to a predetermined size as required. In this embodiment, a laser cuts the formed OPCB 100.

By employing the apparatus and the method, the OPCB 100 can be produced in any size required, and the manufacturing efficiency of the OPCB 100 is improved.

The above particular embodiments and methods are shown and described by way of illustration only. The principles and the features of the present disclosure may be employed in various and numerous embodiments thereof without departing from the scope of the disclosure as claimed. The above-described embodiments illustrate the scope of the disclosure but do not restrict the scope of the disclosure.

What is claimed is:

1. An optical printed circuit board (OPCB), comprising:
a flexible first substrate;
a first cladding layer on the substrate;
a core layer on the first cladding layer, the core layer defining an optical waveguide pattern;
a second cladding layer on the core layer; and
a flexible second substrate positioned on the second cladding layer;
wherein a refractive index of the core layer is greater than a refractive index of the first cladding layer and a refractive index of the second cladding layer.

2. The OPCB of claim 1, wherein a material of the first cladding layer is substantially the same as a material of the second cladding layer.

3. An apparatus for manufacturing an OPCB, comprising:
a working platform;
a first release reel positioned on one end of the working platform and configured for releasing one end of a flexible first substrate;
a first roller pressing device comprising:
a first feeder configure for providing a first cladding layer forming solvent to the first substrate;
a first pressing roller having a smooth rolling surface and cooperating with the working platform to press the first cladding layer forming solvent on the first substrate to obtain a first cladding solvent layer; and
a first drying element configure for solidifying the first cladding solvent layer to obtain a first cladding layer;
a second roller pressing device comprising:
a second feeder configure for providing a core layer forming solvent to the first cladding layer;
a second pressing roller having a rolling surface with an impression pattern and cooperating with the working platform to press the core layer forming solvent on the first cladding layer to form a core solvent layer with an optical waveguide pattern corresponding to the impression pattern; and
a second drying element configure for solidifying the core solvent layer to obtain a core layer;
a third roller pressing device comprising:
a third feeder configure for providing a second cladding layer forming solvent;
a third pressing roller having a smooth rolling surface and cooperating with the working platform to press the second cladding layer forming solvent on the core layer to obtain a second cladding solvent layer; and
a third drying element configure for solidifying the second cladding solvent layer to form a second cladding layer;
a fourth roller pressing device comprising:
a second release reel configured for releasing a second flexible substrate; and
a fourth pressing roller configured for pressing the second flexible substrate on the second cladding layer to obtain an OPCB; and
a film take-up reel positioned on the other end of the working platform and configured for taking up the OPCB;
wherein the first, second, third, and fourth roller pressing devices are arranged in an order from the first release reel to the film take-up reel.

4. The apparatus for manufacturing the OPCB of claim 3, wherein a moving direction of the first substrate is substantially parallel to a length direction of the working platform.

5. The apparatus for manufacturing the OPCB of claim 3, wherein the first drying element, the second drying element, and the third drying element are ultraviolet sources.

6. The apparatus for manufacturing the OPCB of claim 3, wherein the first release reel and the film take-up reel are spaced at a predetermined distance from each other.

7. A method for manufacturing an OPCB, comprising:
providing a flexible first substrate using a first release reel;
forming a first cladding layer on the first substrate using a first roller pressing device;
forming a core layer having an optical waveguide pattern on the first cladding layer using a second roller pressing device;
forming a second cladding layer on the core layer using a third roller pressing device;
forming a flexible second substrate on the second cladding layer using a fourth roller pressing device to obtain an OPCB; and
taking up the OPCB using a film take-up reel;
wherein a refractive index of the core layer is greater than a refractive index of the first cladding layer and a refractive index of the second cladding layer.

8. The method of claim 7, further comprising a step of cutting the OPCB to a predetermined size as required after the step of taking up the OPCB using a film take-up reel.

9. The method of claim 7, further comprising a step of cleaning the first substrate before the step of providing a flexible first substrate using a first release reel.
